(19) United States
(12) Patent Application Publication
(10) Pub. No.: US 2015/0057459 A1
(43) Pub. Date: Feb. 26, 2015

(54) SOLAR DRIVEN SOLVENT EXTRACTOR AND PROCESS FOR EXTRACTION OF MICROALGAL LIPIDS USING THE SAME

(71) Applicant: Council of Scientific & Industrial Research, New Delhi (IN)

(72) Inventors: Pushpito Kumar Ghosh, Gujarat (IN); Sandhya Chandrika Prasad Mishra, Gujarat (IN); Subarna Maiti, Gujarat (IN); Chetan Paliwal, Gujarat (IN); Sanjiv Kumar Mishra, Gujarat (IN); Tonmoy Ghosh, Gujarat (IN); Kaumeel Chokshi, Gujarat (IN); Pankaj Patel, Gujarat (IN); Jitendra Narsinh Bharadia, Gujarat (IN)

(21) Appl. No.: 14/389,824

(22) PCT Filed: Apr. 2, 2013
(86) PCT No.: PCT/IN2013/000218

§ 371 Date: Oct. 1, 2014

(30) Foreign Application Priority Data
Apr. 2, 2012 (IN) 601/DEL/2012
Apr. 2, 2013 (IN) PCT/IN2013/000218

(51) Int. Cl. C11B 1/10; B01D 11/02; B01D 3/40

(52) U.S. Cl. CPC C11B 1/10; B01D 3/40; B01D 11/0296
USPC 554/21; 202/168; 554/20

(57) ABSTRACT

The present invention relates to an energy efficient process for the extraction of non-polar lipids from photosynthetically grown micro-algal biomass using low boiling point solvents and utilizing solar energy for heating as well as chilling operations. The invention also relates to improve energy output to input ratio which is the main hurdle in the micro-algal lipid extraction process. The present invention also relates to the recovery of the solvents used for the above processes via solar energy.

### FIELD OF THE INVENTION

The present invention relates to utilizing solar energy for extraction of lipid fractions desirable from mass cultivated microalgae for production of biodiesel. The lipid bearing microalgae Chlorella variabilis (ATCC No. PTA 12198) is a eukaryotic algae, which is mass cultivated for its lipid content suitable for biodiesel preparation. It utilizes inorganic salts as a medium for its growth. The biomass is harvested and sundried for dewatering and ground to make coarse powder for further extraction procedures.

Conventional lipid extraction is an energy intensive process and need improvements to reduce the energy input to output ratio. Solar energy can be an alternative for its reduction to some extent. Extraction of non-polar lipids from the microalgae via use of low-temperature boiling solvents and their recovery can help in developing an innovative technology for the efficient production of microalgal biofuels. In the present invention, lipid extraction was carried out using parabolic solar dish concentrator and solar panels for deriving the necessary energy for heating as well as chilling from solar radiation. In addition, a parabolic trough was used for necessary recovery of the solvent embedded in the extracted residual biomass.

### BACKGROUND AND PRIOR ART OF THE INVENTION

Reference may be made to information accessible from the internet wherein it is claimed that a company called Origin Oil has developed a methodology for spontaneous oozing out of oil from microalgae due to certain external stimulus. Although this is a breakthrough idea, the majority of work reported in the literature pertains to solvent extraction of lipids from microalgae and there is no reason to believe that this will be dispensed with anytime in the foreseeable future.

Reference may be made to articles “Microalgae for biodiesel production and other applications: A review” by Teresa M. Mata, Antonio A. Martins, Nidia. S. Caetano in Renewable and Sustainable Energy Reviews (2010 volume 14) and “Developments in oil extraction from microalgae” by Paula Mercer and Roberto E. Armenta in Eur. J. Lipid Sci. Technol. 2011, DOI: 10.1002/ejlt.201000455, wherein it is stated that a combination of techniques can yield better results, e.g., subjecting the biomass first to mechanical stresses by expeller, presses, bead beating, autoclaving the biomass, enzymatic pre-treatment etc., prior to solvent extraction.

Reference may be made to article “Microalgae for biodiesel production and other applications: A review” by Teresa M. Mata, Antonio A. Martins, Nidia. S. Caetano in Renewable and Sustainable Energy Reviews (2010 volume 14) wherein it is stated that non-conventional solvent extraction techniques such as with the help of microwave radiation, sonication, etc. can be used for more efficient extraction. Also it is stated that microbial extraction of oil is energy intensive as well as costly. However, these approaches may not be easily scalable not to mention capital and operating costs.

Reference may be made to International Patent Application no. WO/2012/160577, wherein it is shown that high quality biodiesel can be produced using the oil extracted from naturally occurring floating microalgal mats like Microspora (ATCC no PTA12197), Cladophora (ATCC no PTA12199) and photosynthetically grown sun dried Chlorella variabilis (ATCC no PTA12198) biomass. Such extraction was conducted using conventional solvent/Soxhlet extraction methods with non-polar low boiling solvents like hexane utilizing conventional energy sources such as electricity and fossil fuel.

Reference may be made to Laurent Lardon et al in Env. Sci. Technol. 2009, 43, 6475, in their article entitled: Life-Cycle Assessment of Biodiesel Production from Microalgae indicate that the main cost of producing microalgal oil lies in dewatering and extracting oil from the dilute culture.

Reference may be made to Sander et al. Life Cycle analysis of algae biodiesel (Int. J. Life Cycle Assess. 2010, 15:704-714), wherein it is mentioned that thermal dewatering and harvesting of algae consumes 89% of the total energy input i.e. 3556 KJ/kg of water in the biodiesel production process However, the utilization of renewable energy sources for the efficient solvent extraction is not mentioned.

It will be evident to those skilled in the art that the cost of extracting oil is linked to high input energy cost which, additionally, has substantial negative impact on the energy output to input ratio and, consequently, on the viability of microalgal biodiesel. It would therefore be of great interest to conduct such solvent extraction of lipid with renewable energy sources. The energy consumption can be further reduced by employing solar driven cooling device for controlling temperature of the reaction apparatus.

### OBJECTS OF THE INVENTION

The main object of the present invention is to extract lipids from sun dried microalgal biomass with low boiling solvents using solar thermal energy.

Another object is to use non-polar low boiling solvents such as hexane to extract out only those lipids that are particularly suitable for biodiesel while leaving unsuitable materials behind.

Another object is to undertake such solvent extraction preferably with Soxhlet extractor to ensure complete extraction with minimum solvent.

Another object is to recover the lipids free of solvent at the end of the extraction process employing solar thermal distillation.

Another object is to pass cold water through the reflux condenser to minimise solvent loss and by using a solar photovoltaic based chiller.

Another object is to recognise that after the extraction process the biomass contains residual solvent and, accordingly, subjecting the biomass directly to solar heating to strip off and recover the residual solvent.

Another object is to utilise the best practices from the prior art to make the extraction process most efficient while replacing all operations that require conventional power/fossil fuel with solar power.

### BRIEF DESCRIPTION OF THE DRAWINGS

FIG. 1 represents solar driven solvent extractor along with solvent recovery assembly contain collecting vessel (1), solar parabolic dish concentrator (2), black coated rectangular box (3), An extractor column (4), a condenser (5), chiller (6), a battery (7), Solar photo voltaic panels (8), solar parabolic trough (9), an absorber tube (10), condenser (11) and collecting vessel (12) supported with support clamp and stand.

### SUMMARY OF THE INVENTION

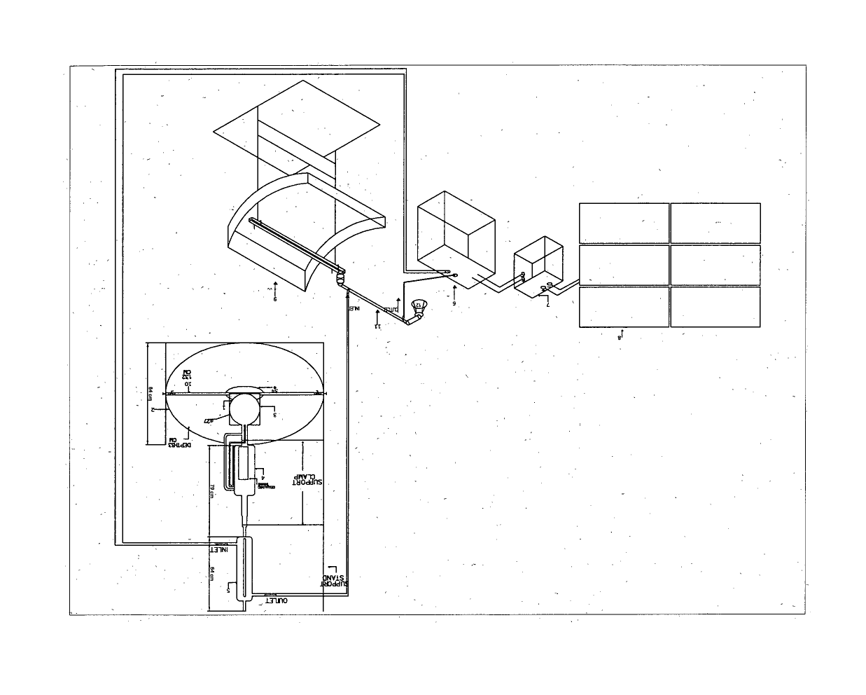

Accordingly, present invention provides solar driven soxhlet extractor comprising:
i. a collecting vessel (1, FIG. 1) placed at the focus of solar parabolic dish concentrator (2, FIG. 1) helping thereby to draw solar thermal energy at the desired temperature to effect the extraction process;
ii. placing the above vessel in a black coated insulating box (3, FIG. 1) covering the four sides to enhance the thermal efficiency of the process by minimizing the effect of convective heat loss due to wind;
iii. placing the extraction column (4, FIG. 1) containing the biomass thimbles over the vessel;
iv. placing the condenser (5, FIG. 1) being connected to a chiller (6, FIG. 1);
v. connecting chiller to the battery (7, FIG. 1) being connected to solar photovoltaic panel (8, FIG. 1);
vi. placing an absorber tube (10, FIG. 1) at the focus of the solar parabolic trough (9, FIG. 1) thereby using solar energy to strip off the solvent embedded in the biomass collected in the collecting vessel (12, FIG. 1) attached to the condenser (11, FIG. 1) and connected to the above said chiller (6, FIG. 1).

In an embodiment of the present invention, said condenser, said extraction column and said collecting vessel are being supported by support clamps and stand.

In another embodiment of the present invention, diameter and focal length of the concentrator is 144 cm and 31 cm respectively for 10 liter capacity and would vary based on the capacity.

In yet another embodiment of the present invention, the concentrator used is selected from solar parabolic dish concentrator, Scheffler concentrator, cylindrical parabolic trough concentrator, compound parabolic concentrator, Fresnel tens, absorber with flat reflectors or combination thereof.

In yet another embodiment of the present invention, chiller is maintained at temperature in the range of 5 to 15° C.

In yet another embodiment of the present invention, battery used for operating the chiller with a minimum capacity of 200 mAh.

In an embodiment, present invention provides a process for the extraction of non-polar lipids from dry micro-algal biomass to improve the energy output to input ratio, using solar driven soxhlet extractor and the said process comprising the steps of:
a. conducting solvent extraction in a conventional Soxhlet apparatus placed at the focus of a solar parabolic dish concentrator;
b. Using solar refrigeration techniques to chill the condenser to minimise solvent losses;
c. placing spent biomass wet with 15 to 30% w/w solvent in the absorber tube of a parabolic trough concentrator and stripping off the adhering solvent;
d. as in the case of b) above, using a chilling facility to minimise evaporation losses;
e. subjecting the solvent extract to solar thermal distillation to isolate the solvent-free non-polar lipids for further processing into biodiesel as per known prior art;
f. as in the case of a) and d) above, using a chilling facility to minimise evaporation losses; photovoltaic modules or and drawing its thermal energy from the solar radiation Sun drying of the harvested microalgae biomass for removal of excess moisture,
g. extracting non-polar lipids with low boiling point solvents using solar parabolic concentrators for heating the collecting vessel of Soxhlet apparatus,
h. distilling the low boiling point solvents using solar parabolic concentrators for heating the collecting vessel of Soxhlet apparatus.

In yet another embodiment of the present invention, said process is run over 3 days with a total run time of 18 hours with the minimum of 5 favorable sunshine hours at 70 to 130° C.

In yet another embodiment of the present invention, average insolation, average ambient temperature and average wind speed is 665 W/m², 28.9° C., and 0.6 m/s, respectively, during the period of the experiment.

In yet another embodiment of the present invention, low boiling point solvents used are selected from the group consisting of n-hexane, toluene, dichloromethane, methanol, acetone, chloroform, cyclohexane, biodiesel or, low boiling fraction of fossil diesel or combination thereof.

In yet another embodiment of the present invention, the solvent recovery efficiency is in the range of 85-95%.

In yet another embodiment of the present invention, the distillation efficiency is in the range of 95-99%.

In yet another embodiment of the present invention, the threshold solar insolation for carrying out the process is 550 W/m².

In yet another embodiment of the present invention, the solar processes is continuous and scalable.

In yet another embodiment of the present invention, any known methods for solvent recovery processes can be used to further improve the efficiency.

In yet another embodiment of the present invention, the energy output to input ratio is improved from a value less than 1/11 to a value more than 1.

In yet another embodiment of the present invention, the process is energy efficient when photo synthetically grown microalgae are utilized with efficient means of harvesting and drying as known in prior art.

In yet another embodiment of the present invention, the chilling operations are conducted by means of either running normal chilling apparatus by using solar PV panels or by using solar absorption refrigeration systems or by running ambient water through pumps running on the PV panels.

In yet another embodiment of the present invention, the lipid recovery is found to be the same as per conventional soxhlet extraction process.

### BRIEF DESCRIPTION OF THE INVENTION

Utilization of solar energy at most of the steps instead of conventional energy involved in solvent extraction of lipids from lipid-bearing microalgae is a unique process since the energy source is a renewable one. It utilizes natural sunlight to heat up the solvent around its boiling point using parabolic solar concentrators along with sun-dried microalgal biomass. The solar extraction methodology also makes the production of biodiesel a cost-effective process by reducing the cost of energy input thereby improving energy output to input ratio. It is especially useful in areas where there is an abundance of solar radiation such as in the tropics.

The utilization of solar energy for the extraction of non-polar lipids from microalgal biomass was carried out using Soxhlet extractor consisting of an extracting column and a condenser. The renewable source of energy utilized in this work is a novel feature of this invention as it considerably reduces the cost of oil extraction that forms the main hindrance in the process. A parabolic dish solar concentrator was employed for this purpose of lipid extraction. The collecting vessel was positioned at the focus of the concentrator and solar radiation was used to heat the solvent to its boiling point. Solar energy was also used for chilling operations via photovoltaic (PV) modules. The recovery of the solvent from the spent biomass was done in the absorber tube of a solar parabolic trough concentrator. The ensuing solvent vapours were passed through a condenser attached to a chiller run by solar PV modules to collect the solvent in a suitable vessel.

The solar driven soxhlet extraction apparatus of FIG. 1, has a total capacity of holding 5 L solvent.

The collecting vessel/round bottom flask is placed at the focus of a solar parabolic dish concentrator as detailed in FIG. 1.

The collecting vessel/round bottom flask at the focus of the parabola is placed inside a black coated insulated box (3) covered on four sides. The solar parabolic dish concentrator (2), is a semi-circular trough made of poly-vinyl chloride plastic with small mirrors fixed on it to collect solar rays onto destined position or focus.

The solar parabolic dish concentrator, has to be tracked according to the day long solar movement to get the maximum solar radiation for heating the 10 L capacity collecting vessel containing the low boiling point solvent.

The extractor column (4), along with the condenser (5) and collecting flask (1), has been given a support using clamps and stands with the solar parabolic dish concentrator represented in FIG. 1.

The condenser, is maintained at 10° C. through the use of a chiller (6) deriving its energy from solar PV modules (8) connected to a battery of 200 mAh (7).

The solar driven soxhlet extraction was run till a colourless extract was observed in the extraction column.

The extract containing concentrated non-polar lipids was pooled in the round bottom flask/collecting flask after siphoning off the solvent collected in the extractor column.

The solvent from the pooled extract was distilled using the solar driven soxhlet extraction system of FIG. 1, without biomass thimbles in the extractor column.

A solar solvent recovery system, as detailed in FIG. 1, consists of solar parabolic trough concentrator (9), an absorber tube (10), a condenser (11) and a collecting vessel (12).

A solar solvent recovery system, as mentioned in FIG. 1, has a total capacity of holding 500 g slurry of extracted biomass containing the embedded solvent for its recovery.

A parabolic solar trough has to be tracked once a day to get maximum solar radiation for heating the glass absorber tube containing the spent biomass to recover the tow boiling point solvents embedded in it.

The solar parabolic trough is made up of anodized aluminium sheet having 1.3 m² area. The condenser is attached to a collecting flask on one side and the absorber tube at the other and is maintained at 10° C. through the use of a chiller deriving its energy from solar PV modules connected to a 200 mAh battery.

The fossil fuel energy input can be minimised using solar inputs.

### NOVEL FEATURES OF THE INVENTION

The main inventive steps are the following:
1. Undertaking a computation of energy balance and showing that more than 10 times as much energy is required to extract out lipid from lipid-bearing microalgal biomass such as Chlorella sp. than the calorie content of the resultant lipid.
2. That one would need to spend energy on other operations such as solvent recovery which would make the energy balance still worse.
3. That non-polar solvents such as hexane, are ideal for recovery of the non-polar lipid fraction and that such solvents are fairly low boiling and amenable to distillation using solar energy.
4. That solar energy may be also considered for other operations such as recovery of residual solvents trapped in the spent biomass and stripping off of solvent from the lipid-containing solvent extract.
5. That whereas the high volatility of hexane is advantageous for the reason mentioned above, there is at the same time a need to chill the condenser to minimise solvent losses and, accordingly, undertaking the chilling operation also using solar photovoltaic power.
6. Recognising that solar radiation is most intense during the period when such microalgae are cultivated and thus the twin objectives of cultivation and lipid extraction can be conveniently synchronized.
7. Recognising further that since such micro-algal biomass as Chlorella variabilis is generated photosynthetically, auto-settles with low water content, and readily harvested and sun-dried as disclosed in the prior art, overcoming the challenge of fossil fuel requirement for lipid extraction from microalgae would enable one to generate the essential raw material—i.e., non-polar lipids—for biodiesel, with low carbon footprint.
8. In sum, successfully altering the energy output to input ratio for lipid extraction from a value <<1 to >1 and thereby also having a favourable outcome on the economics of the process.
9. To recognise that solvent extraction is one of the steps which is throttling the effort to realise a good energy output to input ratio unlike seed oils.
10. To realise no one has suggested a way out of this problem and recognise that the solvent used in the extraction is low boiling solvent and solar energy should be usable for this purpose thereafter, demonstrating parabolic dish configuration as attractive option for this purpose.

The following examples are given by way of illustration and therefore should not be construed to limit the scope of the present invention.

### Example 1

### Construction Feature

The collecting vessel (1) containing the low boiling point solvent such as hexane was placed in the black coated insulated rectangular box (3) covering the four sides of collecting vessel to minimize the convective and radiative losses. The whole assembly (collecting vessel+black coated rectangular box) was placed at the focal point of a solar parabolic dish concentrator (2) having a diameter of 144 cm and focal length of 31 cm. An extractor column (4) of 3 L capacity along with the cellulosic thimbles containing micro-algal biomass was placed over the collecting vessel (1) and was further joined with a condenser (5) connected to a battery (7) operated chiller (6), maintaining a temperature of 10° C., run by Solar photo voltaic panels (8). The setup of collecting vessel, extraction column and condenser was supported by support clamps and stands erected adjacent to the solar parabolic dish concentrator. The wetted micro-algal biomass obtained after extracting lipid from the above said setup is fed into an absorber tube (10), black coated at the bottom, placed at focal point of a solar parabolic trough (9) made up of anodized aluminum of sheet area 1.3 m². The absorber tube is further connected to a condenser (11), attached to the chiller (6) as mentioned above, which is connected to collecting vessel 112) of 500 ml capacity.

### Example 2

Lipid extraction was done in a regular Soxhlet apparatus of capacity 10 L at 80° C. temperature for 16 hrs with 5 L n-hexane from 1 kg of sun-dried Chlorella variabilis (ATCC no. PTA 12198) biomass (moisture content 20%) packed into the cellulosic thimbles kept inside extractor column of the Soxhlet with a condenser above. The condenser was attached to a chiller consuming 5.22 kWh of energy. A heating mantle was used as the heat source which consumed 4 kWh of energy in 18 hour extraction time, after which no lipid extract was visibly seen in the extraction column after which lipid extract was pooled in the round bottom flask. The extract was filtered and filtrate was evaporated to yield 86 g solvent free non-polar lipid. The lipid obtained was 10.75% (w/w) on dry basis.

This example teaches us that the solvent (hexane) extraction of 86 g of non-polar lipids having calorie content of ca. 3 MJ (9100 kcal/kg) required 33 MJ of energy input only for the process, i.e., the energy consumed is 11 times higher.

### Example 3

The experiment of Example 2 was repeated using a parabolic dish solar concentrator as the source of heat and photovoltaic power for chilling of the condenser assembly, as described in the FIG. 1. The flask was positioned at the focus of the concentrator which was made up of small glass mirrors arranged in the shape of a parabola. The diameter of the concentrator was 144 cm and the focal length was 31 cm. The experiment was run over 3 days with a total run time of 18 hours covering the favourable sunshine hours. The average insolation, average ambient temperature and average wind speed were 665 W/m², 28.9° C., and 0.6 m/s, respectively, during the period of the experiment.

A total of 17 Soxhlet cycles were run during this period yielding in total 88 g of non-polar lipid, i.e., a similar amount to that mentioned in Example 2. This example teaches us that solvent extraction is feasible through use of solar energy to facilitate both extraction and condensation.

### Example 4

The table below provides the comparison of the above said processes in Example 2 and Example 3

TABLE 1
Comparative data sheet for the solar driven extraction
and conventional soxhlet extraction

| Parameters | Conventional Soxhlet | | Solar Driven Soxhlet | |
|---|---|---|---|---|
| Biomass capacity | 1 | Kg | 1 | Kg |
| Solvent capacity | 5 | L | 5 | L |
| Extraction time | 18 | h | 18 | h |
| Lipid Yield (%) | 10.75 | | 11 | |
| Energy input | 33.12 | MJ | — | |
| Energy output | 3.27 | MJ | 3.34 | MJ |

### Example 5

500 g of the spent solvent wetted Chlorella variabilis biomass of Example 3, containing approximately 120 g of n-hexane (estimated by taking 5 g sample of the same batch and oven dried at 105° C. for 5 hours), was taken in a glass tube positioned at the line focus of a parabolic trough concentrator, as mentioned in the FIG. 1. One end was closed and the other end was joined to a solvent collecting assembly consisting of a condenser and a pre-weighed collecting flask of 500 ml capacity. The condenser was connected to the same solar-operated chiller used in Example 3. The temperature of the chiller was maintained at 10° C. The parabolic trough was manually tracked and focused to concentrate solar radiation to heat the glass tube containing the wet biomass. After an hour, the collecting flask was weighed and found to contain 102 g of n-hexane i.e. 85% (w/w) recovery efficiency. The average insolation, average ambient temperature and average wind speed were 643 W/m², 27.5° C., and 0.9 m/s, respectively, during the period of the experiment.

This example teaches us that solar energy can be utilized effectively for recovery of solvent from residual biomass

### Example 6

4 L of a solvent extract containing 65.3 g non-polar lipids was taken in a round bottom flask of capacity 10 L and subjected to solvent distillation in the solar Soxhlet assembly of Example 3 except that the thimbles from the extractor column were removed. 3.8 L of hexane was recovered within 2 hours giving a solvent recovery of 95% (v/v).

The average insolation, average ambient temperature and average wind speed were 844 W/m², 25.5° C., and 0.2 m/s, respectively, during the period of the experiment. Examples 2-4 together teach the recovery of non-polar lipids from dry biomass of Chlorella variabilis using solar energy as the sole energy source. These lipids can be, further processed into biodiesel by known prior art.

### ADVANTAGES OF THE PRESENT INVENTION

1. By making use of solar energy, the present invention overcomes one of the main hurdles in the utilization of microalgal biodiesel, namely the high energy requirement for solvent extraction of the non-polar lipids from the intact dry algal biomass.
2. By using solar energy both for heating and chilling operations required in the process of extraction and solvent recovery, the carbon footprint of the process is further minimised.
3. By avoiding the use of fossil fuel, the energy cost is greatly reduced.
4. Since solar concentrations are readily scaled up, the process too can be scaled up.

1. Solar driven soxhlet extractor comprising:
i. a collecting vessel placed at the focus of solar parabolic dish concentrator helping thereby to draw solar thermal energy at the desired temperature to effect the extraction process;
ii. placing the above vessel in a black coated insulating box covering the four sides to enhance the thermal efficiency of the process by minimizing the effect of convective heat loss due to wind;
iii. placing the extraction column containing the biomass thimbles over the vessel;
iv. placing the condenser being connected to a chiller;
v. connecting said chiller to the battery being connected to solar photovoltaic panel;
vi. placing an absorber tube at the focus of the solar parabolic trough J9, FIG. 1) thereby using solar energy to strip off the solvent embedded in the biomass collected in the collecting vessel attached to the condenser and connected to the above said chiller.

2. The solar driven soxhtet extractor as claimed in claim 1, wherein said condenser, said extraction column and said collecting vessel are being supported by support clamps and stand.

3. The solar driven soxhlet extractor as claimed in claim 1, wherein diameter and focal length of the concentrator is 144 cm and 31 cm respectively for 10 liter capacity.

4. The solar driven soxhlet extractor as claimed in claim 1, wherein the concentrator used is selected from solar parabolic dish concentrator, Scheffler concentrator, cylindrical parabolic trough concentrator, compound parabolic concentrator, Fresnel lens, absorber with flat reflectors or combination thereof.

5. The solar driven soxhlet extractor as claimed in claim 1, wherein said chiller is maintained at temperature in the range of 5 to 15° C.

6. The solar driven soxhlet extractor as claimed in claim 1, wherein battery used for operating said chiller with a minimum capacity of 200 mAh.

7. A process for the extraction of non-polar lipids from dry micro-algal biomass to improve the energy output to input ratio using solar driven soxhlet extractor as claimed in claim 1 and the said process comprising the steps of:
a. conducting solvent extraction in a conventional Soxhlet apparatus placed at the focus of a solar parabolic dish concentrator;
b. using solar refrigeration techniques to chill the condenser to minimise solvent losses;
c. placing spent biomass wet with 15 to 30% w/w solvent in the absorber tube of a parabolic trough concentrator and stripping off the adhering solvent;
d. as in the case of b) above, using a chilling facility to minimise evaporation losses;
e. subjecting the solvent extract to solar thermal distillation to isolate the solvent-free non-polar lipids for further processing into biodiesel as per known prior art;
f. as in the case of a) and d) above, using a chilling facility to minimise evaporation losses; photovoltaic modules or and drawing its thermal energy from the solar radiation Sun drying of the harvested microalgae biomass for removal of excess moisture,
g. extracting non-polar lipids with low boiling point solvents using solar parabolic concentrators for heating the collecting vessel of Soxhlet apparatus.
h. distilling the low boiling point solvents using solar parabolic concentrators for heating the collecting vessel of Soxhlet apparatus.

8. The process as claimed in claim 7, wherein said process is run over 3 days with a total run time of 18 hours with the minimum of 5 favorable sunshine hours at 70 to 130° C.

9. The process as claimed in claim 7, wherein average insolation, average ambient temperature and average wind speed is 665 W/m², 28.9° C., and 0.6 m/s, respectively, during the period of the experiment.

10. The process as claimed in claim 7, wherein low boiling point solvents used are selected from the group consisting of n-hexane, toluene, dichloromethane, methanol, acetone, chloroform, cyclohexane, biodiesel or low boiling fraction of fossil diesel or combination thereof.

11. The process as claimed in claim 7, wherein the solvent recovery efficiency is in the range of 85-95%.

12. The process as claimed in claim 7, wherein the distillation efficiency is in the range of 95-99%.

13. The process as claimed in claim 7, wherein the threshold solar insolation for carrying out the process is 550 W/m².

14. The process as claimed in claim 7, wherein the solar processes is continuous and scalable.

15. The process as claimed in claim 7, wherein any known methods for solvent recovery processes can be used to further improve the efficiency.

16. The process as claimed in claim 7, wherein the energy output to input ratio is improved from a value less than 1/11 to a value more than 1.

17. The process as claimed in claim 7, wherein the process is energy efficient when photo synthetically grown microalgae are utilized with efficient means of harvesting and drying as known in prior art.

18. The process as claimed in claim 7, wherein the chilling operations are conducted by means of either running normal chilling apparatus by using solar PV panels or by using solar absorption refrigeration systems or by running ambient water through pumps running on the PV panels.

19. The process as claimed in claim 7, wherein the lipid recovery is found to be the same as per conventional soxhlet extraction process.
